(19) United States
(12) Patent Application Publication
(10) Pub. No.: US 2006/0054678 A1
(43) Pub. Date: Mar. 16, 2006

(54) Cash register money tray bill weight structure

(75) Inventor: Wei-Yu Chang, Taipei City (TW)

Correspondence Address: Troxell Law Office PLLC, Suite 1404, 5205 Leesburg Pike, Falls Church, VA, 22041, US

(73) Assignee: Shyh Ru Metallic Industrial Corp.

(21) Appl. No.: 10/937,415

(22) Filed: Sep. 10, 2004

(51) Int. Cl. G07G 1/00

(52) U.S. Cl. 235/7 R

(57) ABSTRACT

A cash register money tray bill weight structure in which a base mount is disposed across the rear end of bill compartments in a cash register money tray, the selected base mount having a U-shaped hinge section at its front edge, with a pivot hole at each of the two sides of the U-shaped hinge section. The inner end areas of the two pivot holes are opened laterally outward and downward at an angle into symmetrical slanted surfaces, a stop section of relatively narrower width is articulated contiguously by lateral inward extension from the rear lateral upper end of the symmetrical slanted surfaces, and a notch-shaped detent section is contiguously formed at the rear side of each stop section. As such, this provides for the insertion of hinge pins at the two lateral extremities of a U-shaped weight bar into the pivot holes and utilizing the inherent elasticity of the weight bar in coordination with the hinge section slanted surfaces, stop sections, and detent sections to form a structurally simple and elastic pressure-based bill weight structure.

### BACKGROUND OF THE INVENTION

### 1) Field of the Invention

The invention herein relates to a cash register money tray bill weight structure.

### SUMMARY OF THE INVENTION

The primary objective of the invention herein is to provide a cash register money tray bill weight structure design in which the design of the cash register money tray and bill weight structure is further improved to thereby achieve bill securing capability objectives, including the further simplification of fabrication and assembly procedures, convenient assembly and disassembly and, furthermore, the lowering of production costs.

Based on the said objectives, the embodiment of the invention herein provides for a base mount disposed respectively or as a one-piece construct at the rear end of a plurality of bill compartments in a cash register, selecting a base mount having a U-shaped hinge section at its front edge, with a pivot hole at each of the two sides of the U-shaped hinge section; the inner end areas of the two pivot holes are opened laterally outward and downward at an angle into symmetrical slanted surfaces and, as such, a stop section of relatively narrower width is articulated contiguously by inward extension from the rear lateral upper end of the symmetrical slanted surfaces, and a notch-shaped detent section is contiguously formed at the rear side of each stop section such that the two detent sections are symmetrical and situated at a relatively wider distance apart; as such, this provides for the insertion of hinge pins at the two lateral extremities of a U-shaped weight bar into the pivot holes and utilizing the inherent elasticity of the weight bar in coordination with the hinge section slanted surfaces, stop sections, and detent sections to form a structurally simple and elastic pressure-based bill weight structure that achieves the objectives of the invention herein.

### BRIEF DESCRIPTION OF THE DRAWINGS

FIG. 1 is an isometric drawing of a conventional cash register and money tray.

FIG. 2 is a cross-sectional drawing of the conventional money tray and spring-loaded weight bar structure.

FIG. 3 is an isometric drawing of the money tray and weight bar of the invention herein.

FIG. 4 is an exploded drawing of the base mount hinge section and the weight bar of the invention herein.

FIG. 5 is an orthographic drawing of the base mount hinge section and the weight bar of the invention herein.

FIG. 6 is a cross-sectional drawing of the weight bar lifting utilization of the invention herein.

FIG. 7 is an orthographic drawing of the weight bar downward pressure utilization of the invention herein.

FIG. 8 is an orthographic drawing of the invention herein that illustrates the weight bar lifting operation.

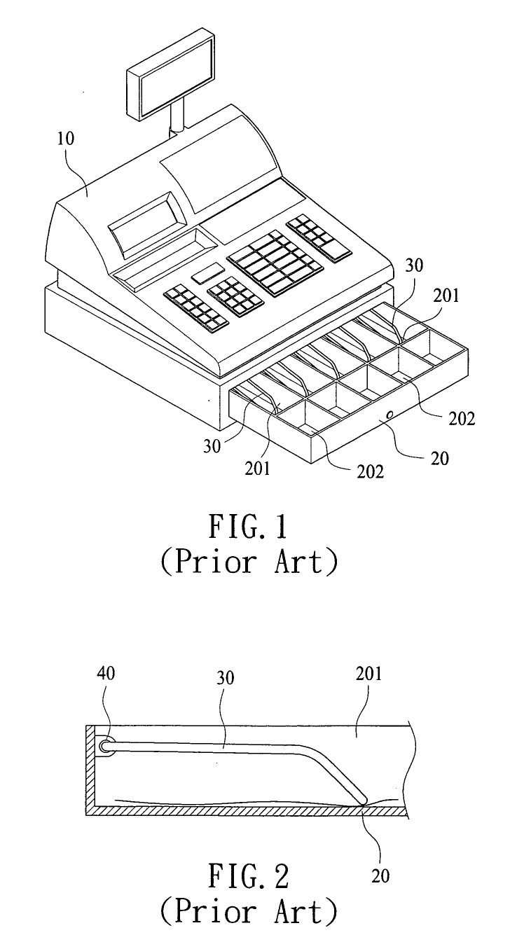

### DETAILED DESCRIPTION OF THE INVENTION

Accompanied by the brief description of the drawings, the structural features as well as other applications and objectives are elaborated in the following detailed description of the invention herein.

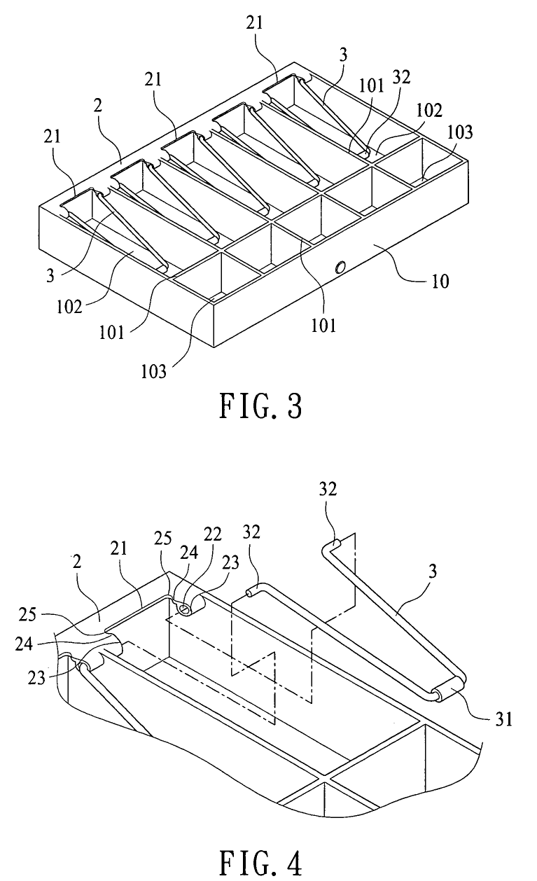

As shown in the drawings, the cash register money tray bill weight structure design of the invention herein further improves the money tray structure 10 and, therefore, other cash register mechanisms are not elaborated; the bill weight structure of the invention herein is comprised of a money tray 10, a base mount 2, and a weight bar 3; referring to FIG. 3, the said money tray 10 of the invention herein consists of a one-piece molded or fabricated rectangular, shallow drawer, with a plurality of one-piece molded or fabricated separator plates 101 in the drawer partitioning a plurality of bill compartments 102 and coin compartments 103 for respectively containing money.

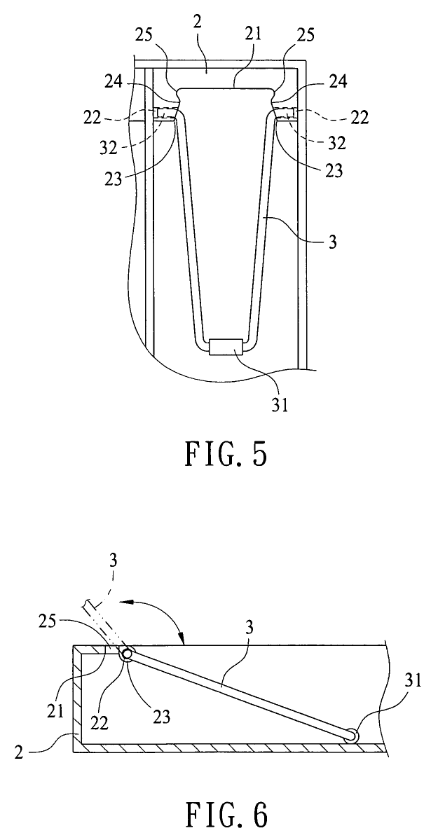

Referring to FIG. 4 and FIG. 5, a one-piece molded or fabricated base mount 2 is selected and disposed at the rear end and upper extent of the said bill compartments 102 such that the said base mount 2 is disposed across the rear end of the bill compartment 102 and has a U-shaped hinge section 21 at the front edge of the selected said base mount 2, with a pivot hole 22 at each of the two sides of the U-shaped hinge section 21; the inner end areas of the two pivot holes 22 are opened laterally outward and downward at an angle into symmetrical slanted surfaces 23, a stop section 24 of relatively narrower width is articulated contiguously by lateral inward extension from the rear lateral upper end of the symmetrical slanted surfaces 23, and a notch-shaped detent section 25 is contiguously formed at the rear side of each stop section 24 such that the two detent sections 25 are symmetrical and situated at a relatively wider distance apart.

As shown in FIG. 4, the said weight bar 3 is of one-piece construction in a U-shaped or V-shaped arrangement, a roller 31 is sleeved onto the front side, and the rear side width is slightly greater than that of the said hinge section 21; furthermore, the two extremities are bent outward into hinge pins 32 that fit into the base mount 2 pivot holes 22 to form a movable linkage.

As such, the two hinge pins 32 of the said weight bar 3 are respectively inserted into the two pivot holes 22 of the base mount 2, enabling the weight bar 3 to become a liftable structure on the money tray 10 (bill compartments 102) such that when folded down, the roller 31 is situated against the money tray 10 bottom surface, constituting the elastic pressure-based bill weight structure of the present invention that is capable of achieving the bill securing objectives of the invention herein.

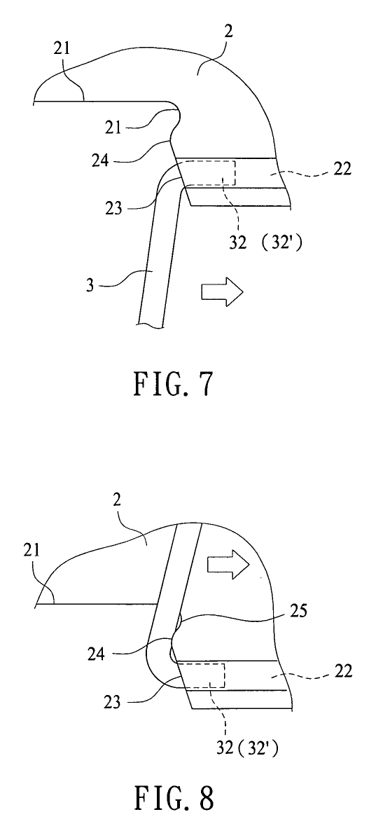

Referring to FIG. 6, the said weight bar 3 of the invention herein can be postured in any lifted state; when generally utilized to secure bills, a foundation is created by the force distribution at the two slanted surfaces 23 of the said hinge section 21 and, as such, referring to FIG. 7, the said weight bar 3 utilizes its inherent outward tension against the slanted surfaces 23, naturally producing downward rotation and elastic pressure capability, thereby achieving the objective of holding down bills; referring to FIG. 7, when the user wants to place or remove bills, the said weight bar 3 is lifted up, causing the two sides of the weight bar 4 to pass over the slanted surfaces 23 and then the rear end of the stop section 24, following which inherent outward tension impels them to a stationery position at the said detent section 25, thereby providing for bill placement and removal, and amply demonstrating that the present invention has bill securing capability. Notably, since the base mount 2, hinge section 21, pivot holes 22, slanted surfaces 23, stop section 24, detent section 25, and other structural features of the invention herein can be fabricated as a one-piece construct and, furthermore, with the weight bar 3 still having the securing capability, the present invention affords production and assembly simplicity, convenient assembly and disassembly, as well as the positive advantage of reduced cost.

Referring to FIG. 3 and FIG. 4, since the said base mount 2 of the invention herein can be manufactured utilizing sheet metal punch fabrication to form a consecutive quantity of adjacent bill compartment 102 base mounts 2 and, as such, respectively disposing the said hinge sections 21 at the corresponding bill compartments 102 and, furthermore, bending the one-piece contiguous pivot holes 22 along with the said slanted surfaces 23, stop sections 24, detent sections 25, and other structures, the production method is not limited to a single type. Additionally, referring to FIG. 7 and FIG. 8, the said stop section 24 of the invention herein can be disposed as a curved protrusion that enables the weight bar 3 to slide even more smoothly during the lifting operation and, furthermore, the said detent section 25 can be formed as an arcuate recess capable of efficiently receiving the weight bar 3 to form an engagement.

Furthermore, referring to FIG. 7 and FIG. 8, since the two hinge pins 32′ at the extremities of the U-shaped weight bar 3 can be bent inward, enabling the weight bar 3 to pinch the two notch-shaped hinge section 21 adjacent slanted surfaces 23 such that the two hinge pins 32′ of the weight bar 3 are respectively inserted into the pivot holes 22 of the two notch-shaped hinge section 21 adjacent slanted surfaces 23 and, as such, utilizing the inward laterally directed elastic force of the weight bar 3′ exerted toward the said slanted surfaces 23 structure to produce the same said bill securing operation and capability, the said weight bar 3 of the invention herein can be simply modified to suit application requirements; however, all fundamental modifications and adaptations based on the disclosed structural features of the said base mount 2 of the invention herein shall remain included in the claims of the present invention.

In summation of the foregoing section, the cash register money tray bill weight structure of the invention herein is practical and progressive, the means utilized have been demonstrated to be original and, furthermore, the performance and design objectives are reasonable advances. As such, the invention herein is lawfully submitted to the patent bureau in application for review and the granting of the commensurate patent rights.

1. A cash register money tray bill weight structure comprised of:
A money tray having a plurality of bill compartments partitioned in a drawer.
A base mount disposed across the rear end and upper extent of the said bill compartments, the selected said base mount having a U-shaped hinge section at its front edge, with a pivot hole at each of the two sides of the said U-shaped hinge section; the inner end area of at minimum one said pivot hole is opened laterally outward at an angle into a slanted surface; of a narrower width end selected at the said slanted surface relative to the said pivot hole at the other side, a stop section is disposed that extends laterally inward, and a notch-shaped detent section is contiguously formed at the rear side of each said stop section such that the said detent sections are situated at a wider distance apart relative to the other said pivot hole.
A weight bar formed into a U-shaped arrangement, with each the rear lateral two extremities respectively bent into a hinge pin.
As such, the two said hinge pins of the said weight bar are respectively inserted into the two said pivot holes of the said base mount, enabling the said weight bar to become a liftable structure on the said money tray and constitute an elastic pressure-based bill weight structure.

2. As mentioned in claim 1 of the cash register money tray bill weight structure of the invention herein, the said hinge section includes another said pivot hole at the opposite side, the inner end area of which is opened laterally outward at an angle into the said slanted surface; of a narrower width end selected at the said slanted surface relative to the said pivot hole at the other side, the said stop section is disposed that extends laterally inward, and the said notch-shaped detent section is contiguously formed at the rear side of each said stop section such that the said detent sections are situated at a wider distance apart relative to the said outer pivot hole.

3. As mentioned in claim 1 of the cash register money tray bill weight structure of the invention herein, the said weight bar hinge pins are formed by bending outward.

4. As mentioned in claim 1 of the cash register money tray bill weight structure of the invention herein, the said weight bar hinge pins are formed by bending inward.

5. As mentioned in claim 1 of the cash register money tray bill weight structure of the invention herein, the said stop section can be disposed as a curved protrusion and, furthermore, the said detent section can be formed as an arcuate recess.

6. As mentioned in claim 1 of the cash register money tray bill weight structure of the invention herein, the said base mount can be manufactured utilizing sheet metal punch fabrication to form a consecutive quantity of adjacent said bill compartment base mounts and, as such, respectively disposing the said hinge sections at the corresponding said bill compartments.

7. As mentioned in claim 1 of the cash register money tray bill weight structure of the invention herein, the said weight bar can formed into a V-shaped arrangement.

8. As mentioned in claim 2 of the cash register money tray bill weight structure of the invention herein, the said stop section can be disposed as a curved protrusion and, furthermore, the said detent section can be formed as an arcuate recess.

9. As mentioned in claim 2 of the cash register money tray bill weight structure of the invention herein, the said base mount can be manufactured utilizing sheet metal punch fabrication to form a consecutive quantity of adjacent said bill compartment base mounts and, as such, respectively disposing the said hinge sections at the corresponding said bill compartments.

10. As mentioned in claim 2 of the cash register money tray bill weight structure of the invention herein, the said weight bar can formed into a V-shaped arrangement.
